(19) United States
(12) Patent Application Publication
(10) Pub. No.: US 2004/0070600 A1
(43) Pub. Date: Apr. 15, 2004

(54) System and method for displaying images and video within a web page

(76) Inventors: Lawrence E. Morrisroe, Cupertino, CA (US); Jack Chu, Sunnyvale, CA (US); Christopher John Mancini, Plano, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/260,134

(22) Filed: Sep. 27, 2002

(51) Int. Cl. G09G 5/00

(52) U.S. Cl. 345/738

(57) ABSTRACT

A system and method for displaying images and video with a web page are disclosed. In one embodiment, images and video may be displayed in a web page by providing a web page including a display window, a timer, and a video retrieval module. The timer may commence upon the web page being downloaded into a browser at a client device. The web page displays a first image in the display window and plays at least a portion of a first video file within the display window in response to entry of a play command. The web page displays a second image in the display window in response to the expiration of a predetermined time as determined by the timer and no entry of the play command.

### TECHNICAL FIELD

The present system and method relate to display of images, text, and video data and, in particular, to a system and method for displaying image, text, and video data on a web page.

### BACKGROUND

The Internet is a robust, Wide Area Network (WAN) of networks that permits communications among computers, networks, and other digital devices, which may adhere to standard TCP/IP or other suitable protocol. One common way of communicating over the Internet is through a web site, which may be hosted at one or more servers. Users at client devices may communicate with the web site via a browser. Web pages may be uploaded to these servers and comprise parts of the web site. In many instances, the web pages are documents written in code, such as HTML (HyperText Markup Language), or the like.

Many conventional web pages are static in nature and are unable to easily display image and video data to a user at a client device in a convenient and dynamic manner. Pursuant to some conventional approaches, display of video data requires opening an application separate from the browser and playing the video data within the separate application. The separate application may also open a new window associated with the separate application. The separate application may, for example, comprise Windows MediaPlayer™ by Microsoft Corporation or RealOne Player™ of RealNetworks, Inc. Opening a separate application may introduce delay in displaying video data.

Typically, when the separate application opens, the separate application displays a window on top of the web page being viewed, thereby limiting the viewable area of the underlying web page. The window associated with the separate application may also have a look and feel and associated branding that may be undesirable in some circumstances.

In addition, the separate application may have certain buffering requirements. The user must typically wait while the separate application buffers sufficient video data to satisfy these buffering requirements. The time associated with this buffering may add additional delay.

### SUMMARY

A need exists, therefore, for a system and method for displaying images and video in a web page. Another need exists to provide a system and method by which video data may be displayed to a user that does not require opening a separate application and a separate window associated with that application.

Pursuant to some embodiments, a method is provided for displaying images and video within a web page. Initially, a user downloads a web page including a display window, a timer, and a video retrieval module. Upon the web page loading into a browser, the timer commences and the web page displays a first image in the display window. In response to entry of a play command, the web page plays at least a portion of a first video file within the display window. The web page displays a second image in the display window if the user has not entered a play command before the expiration of a predetermined amount of time as determined by the timer. The web page may subsequently display other images in the display window at intervals determined by the timer.

The timer and video retrieval modules may comprise components of applications, or scripts, embedded in the web page. These modules may respectively comprise ActionScript and JavaScript code.

The web page may also include a page data module for retrieving page data from a remote server over a network. The page data may include, for example, a first video file identifier, a first video file format identifier, a first set of text, a first hyperlink, and a first image identifier. In one embodiment, the page data may comprise an XML feed. The modules of the web page use the first image identifier to download the first image and use the first video file identifier to download the first video file from one or more remote servers over a network.

Further, the modules of the web page may be configured to display the first set of text and the first hyperlink in a text field adjacent the display window on the web page. The first hyperlink may comprise a link to a web page associated with the first image, the first set of text, and the first video file. The web page may use the first video file format identifier to determine an aspect ratio of the first video file for the display window. The first video file may be played within the display window by streaming the first video file.

In some embodiments, before playing the first video file, one or more embedded sniffer modules on the web page determine whether a client device at which the web page is downloaded has an appropriate plug-in installed.

The first image may comprise a first frame or other frame of the first video file. Optionally, the first image may comprise an image different from the frames of the first video file.

In another embodiment, a method is provided for displaying images and video within a web page, that includes a display window, a text field, an embedded page data retrieval module and an embedded video retrieval module. Page data, such as in the form of an XML feed, is downloaded separate from the web page and may include an image identifier, a video file identifier, and text associated with the image identifier. A first image is then downloaded using the image identifier and displayed at the display window. Upon entry of a play command, the web page plays at least a portion of a first video file associated with the video file identifier within the display window. A set of text associated with the image identifier is displayed in the text field, which may be positioned adjacent the display window.

Pursuant to yet another embodiment, a method for displaying video within a web page includes downloading a web page including a display window, a timer, and a video retrieval module. The timer commences operation upon the web page being loaded into a client browser. At least a portion of a first video file is then played within the display window. Subsequently, at least a portion of a second video file, separate from the first video file, is played within the display window in response to the end of the first video file or in response to the expiration of a predetermined time as determined by the timer.

Additional details, features, and advantages of the present system and method will be apparent to those skilled in the art by the following detailed description and the accompanying drawings.

### BRIEF DESCRIPTION OF THE DRAWINGS

FIG. 1 is a simplified network diagram illustrating an example environment in which embodiments of the present invention may be practiced.

FIG. 2 illustrates details of an example embodiment of a FIG. 1 client.

FIG. 3 illustrates a web page in accordance with an example embodiment of the present invention.

FIGS. 4A and 4B illustrate functional diagrams of applications embedded in the FIG. 3 web page.

FIG. 5 is a flowchart illustrating method steps in accordance with an example embodiment of the present invention.

Common reference numerals are used throughout the drawings and detailed description to indicate like elements.

### DETAILED DESCRIPTION

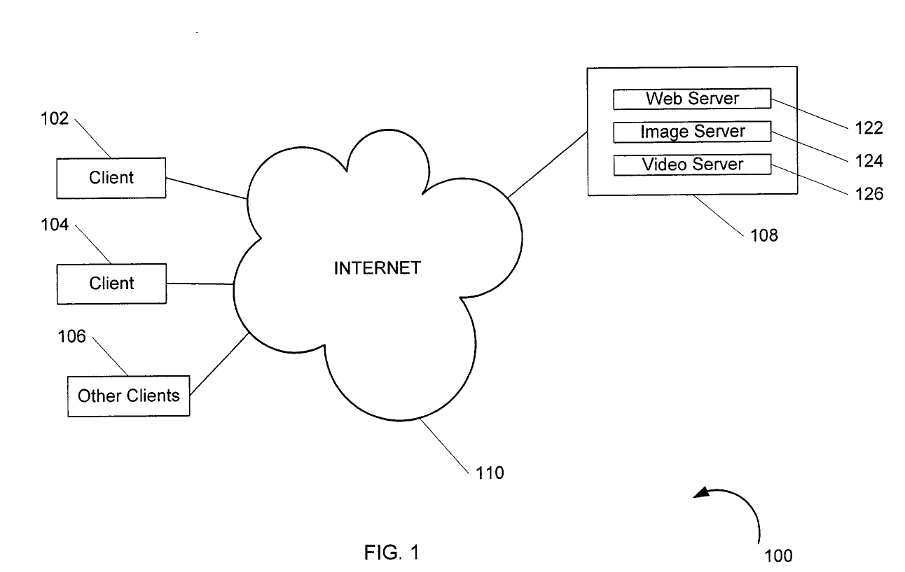

FIG. 1 illustrates a system 100 in which embodiments of the present invention may be practiced. As shown, the system 100 includes a client device 102, a client device 104, and other client devices 106 linked to server cluster 108 via network 110, such as the Internet. Each of the client devices 102, 104, 106 may comprise, for example, a personal computer, a cellular telephone, a Personal Digital Assistant (PDA), or other suitable device. To facilitate communications with the web server 122, each client device 102, 104, 106 includes an internet browser, such as Internet Explorer™ by Microsoft Corporation or Netscape Navigator™ by Netscape Communications Corporation. Other suitable internet browsers may alternatively be employed.

In some embodiments, each of the client devices 102, 104, 106 is linked to the network 110 by a broadband connection, such as a connection having a data rate of about 300 kbps in the downstream direction. Example connections between each client device 102, 104, 106 and the network 110 include an xDSL (e.g. ADSL, VDSL, HDSL) connection, a cable modem connection, an ISDN connection, a wireless connection, a fiber optic connection, a combination of the foregoing, or other suitable wired or wireless network connection. Non-broadband connections, including conventional dial-up connections, may alternatively be employed. Further, one or more devices (not shown), such as proxy computers, firewalls, data packet forwarding devices, or the like, may be disposed between the client devices 102, 104, 106 and the server cluster 108.

In this configuration, the client devices 102, 104, 106 may request information from the server cluster 108 over the network 110. Likewise, the client devices 102, 104, 106 may receive information from the server cluster 108 over the network 110.

As shown in FIG. 1, the server cluster 108 may include one or more servers for transmitting information to one or more of the client devices 102, 104, 106 over the network 110. In the illustrated embodiment, the server cluster 108 includes a web server 122, an image server 124, and a video server 126. Those skilled in the art will appreciate that the functionality of the servers 122, 124, 126 may be performed by a single server. Alternatively, the functionality of each server 122, 124, 126 may be performed by multiple servers.

In general, and as discussed in more detail below, pursuant to some embodiments, a user at a one of the client devices 102, 104, 106 may request a web page from the web server 122, such as by transmitting an HTTP request. The web server 122, in response, transmits a web page associated with the request from the client device. The web page may comprise a file coded in HTML and includes one or more embedded scripts for receiving and displaying images, video, or both at the client device. Details regarding the client device 102, 104, 106, the server cluster 108, and communications therebetween are discussed in more detail below.

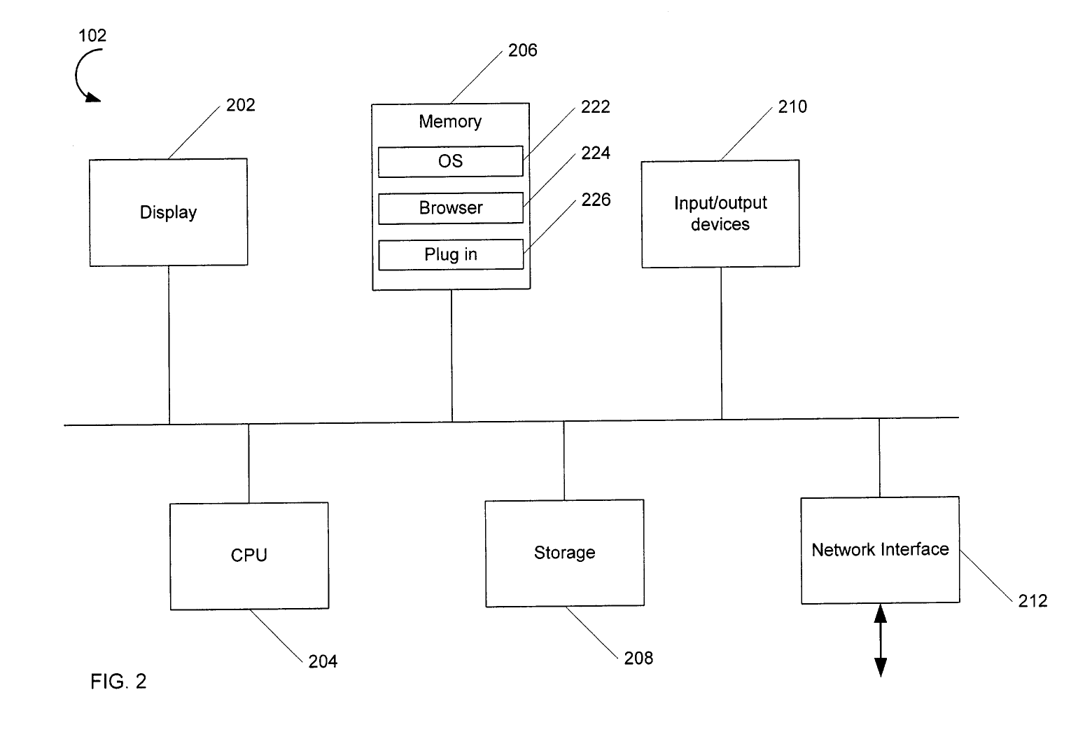

FIG. 2 illustrates details of an example embodiment of the client device 102 of FIG. 1. As shown, the client device 102 includes a display 202, a CPU (Central Processing Unit) 204, memory 206, a storage device 208, input/output devices 210, and a network interface 212 coupled by at least one bus 214.

In this example embodiment, the display 202 may comprise a conventional display monitor, such as a CRT, LED, or other suitable display for displaying information, such as text, images, and video data to a user. The CPU 204 may comprise one or more of a variety of conventional processors, such as Pentium IV™ processor by Intel Corporation or other suitable processor or processors. The memory 206 may comprise volatile memory, nonvolatile memory, or both. As shown, the memory 206 may include an operating system 222, an internet browser 224, and a plug-in 226. The plug-in 226 may comprise a conventional media player, such as Macromedia Flash Player 6 available from Macromedia, Inc. Details regarding the plug-in 226 are discussed below. The storage device 208 may comprise any of a variety of data storage devices, such as a conventional hard drive. The input/output devices 210 may comprise a keyboard, mouse, audio speakers, or the like for permitting user input into the client device 102 and permitting receipt of output therefrom. The network interface 212 may comprise any of a variety of conventional network interfaces, including, for example a network interface card (NIC), a modem, or other suitable wired or wireless network interface device for permitting the client device 102 to exchange data with other devices over the network 110.

The client devices 104, 106 may be configured identical to the client device 102 and, thus further description of the client devices 104, 106 is unnecessary. In other embodiments, the specific configurations of the client devices 102, 104, 106 may vary.

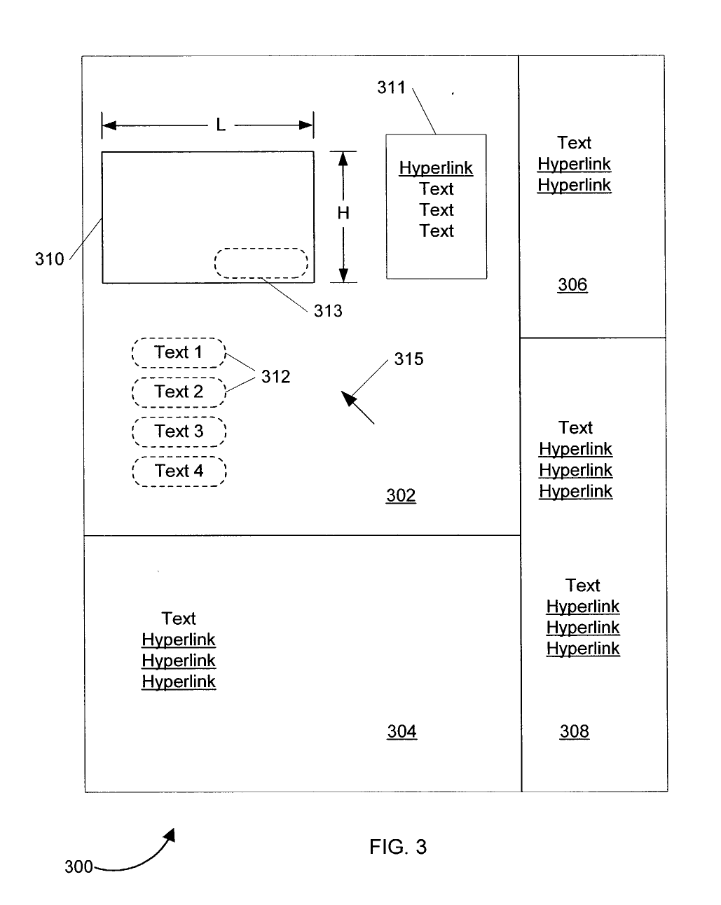

FIG. 3 illustrates an example web page 300 as might be viewed within a browser window at the display 202 (FIG. 2) of one or more of the client devices 102, 104, 106. The illustrated web page 300 is exemplary and those skilled in the art will appreciate the specific layout of the web page 300 may vary greatly. The details of the web page 300 are described herein for purposes of describing example embodiments.

As shown, the web page 300 comprises sections 302, 304, 306, 308. The section 302 includes a display window, or region, 310 having a length L and a height H. In one embodiment, the length L may comprise 200 pixels and the height H may comprise 150 pixels, although the size and aspect ratio of the display window 310 may vary. The section 302 also includes text field 311 adjacent the window 310. The text field 311 may include a hyperlink and associated text as discussed in more detail below.

As those skilled in the art will appreciate, a hyperlink or “hypertext link” generally comprises a selectable connection from one word, picture, or information object to another. In a multimedia environment such as the World Wide Web, such objects can include sound and motion video sequences. One common form of a hyperlink is a highlighted word or picture that can be selected by the user (with a mouse or in some other fashion), resulting in the immediate delivery and view of another file.

Further, the section 302 may also include buttons 312, which may comprise hyperlinks or JavaScript buttons operable to generate JavaScript calls. Details of the purpose and operation of the buttons 312 are described below.

Each of the other sections 304, 306, 308 may include text and hyperlinks. Pursuant to some embodiments, the hyperlinks may link to other web sites, email applications, calendar applications, other web pages, images or the like. In some embodiments, the web page 300 comprises only the section 302 or multiple ones of the section 302 and does not include the other sections 304, 306, 308.

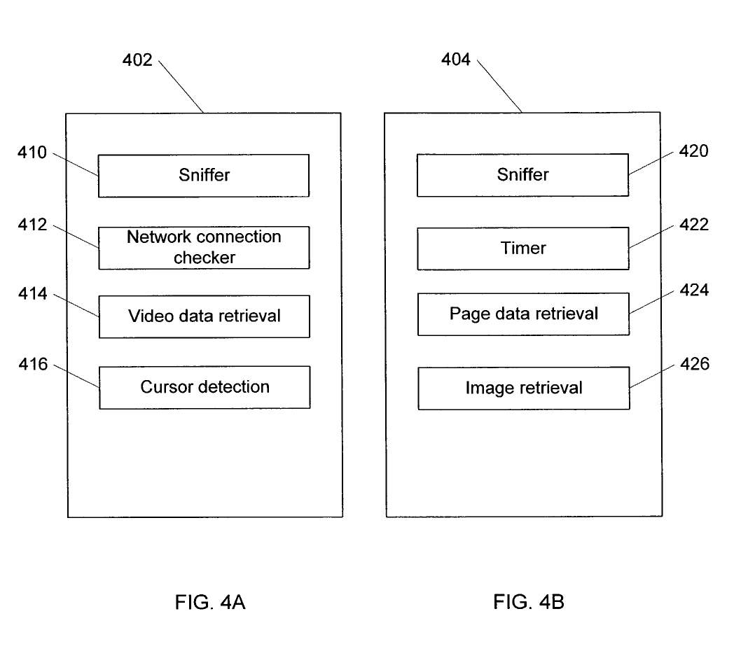

The web page 300 also includes embedded applications, or scripts, (see, FIGS. 4A and 4B), which may comprise ActionScript, JavaScript, or other suitable code. The embedded applications may each be disposed between object tags within the web page 300. Details of the embedded application are set forth below with reference to FIGS. 4A and 4B.

FIGS. 4A and 4B are simplified functional diagrams that illustrate details of one example embodiment of embedded programs 402 and 404, which may be embedded in the web page 300 (FIG. 3). In one embodiment, the program 402 of FIG. 4A comprises ActionScript code that may be executed by the plug-in 226 (FIG. 2) and the program 404 of FIG. 4B comprises JavaScript code that may be executed by the browser 224 (FIG. 2). Those skilled in the art will appreciate that the embedded programs 402, 404 may be configured differently and still perform similar or same functionality. Moreover, while the functionality of the embedded programs 402, 404 is described as being performed by the programs 402, 404, in other embodiments, this functionality may be performed by additional or alternative programs, and may be written in any suitable programming language.

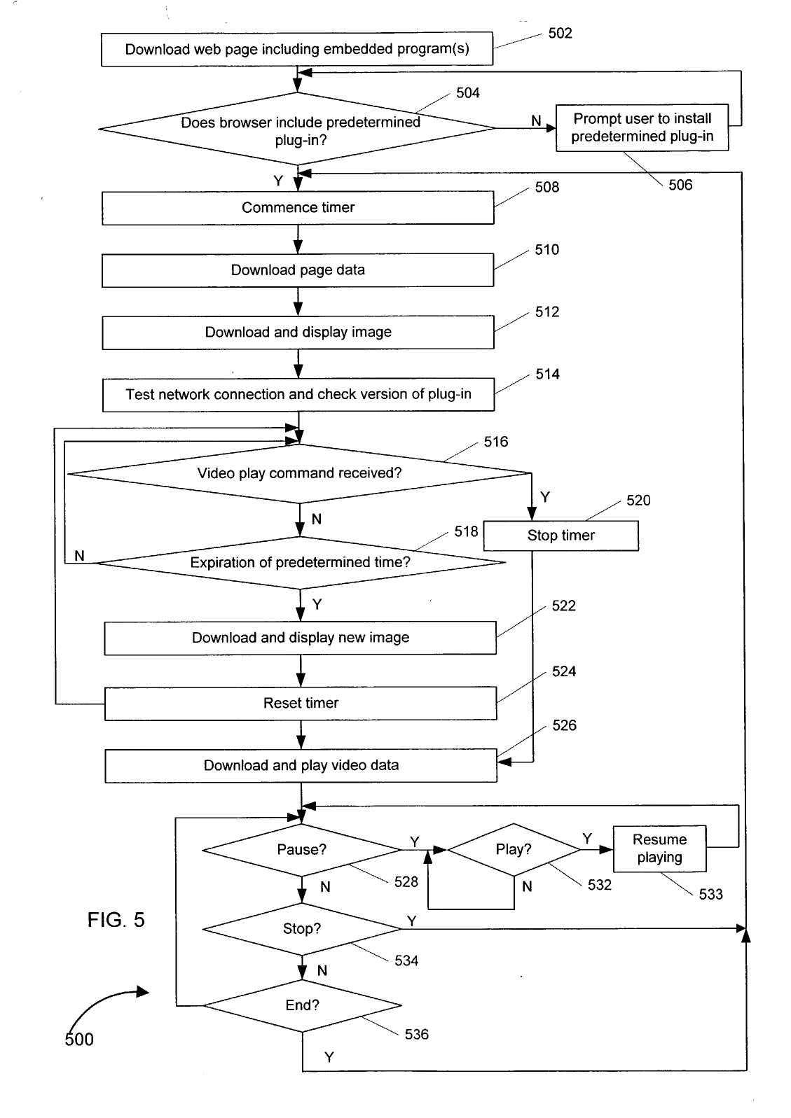

The program 402 (FIG. 4A) is shown as including a sniffer 410, a network connection checker 412, a video data retrieval module 414, and a cursor detection module 416. In general, the sniffer 410 detects a version of the plug-in 226 (FIG. 2) and presents the user with a message within the window 310 (FIG. 3) if the plug-in 226 is not of at least a predetermined version. The network connection checker 412 performs a network connection check, such as by pinging one or more servers of the server cluster 108. As those skilled in the art appreciate, “pinging” generally refers to verifying that an IP address exists and accepts requests. By pinging one or more servers of the server cluster 108, the network connection checker 412 confirms the presence of an effective network connection. The cursor detection module 416 determines when a cursor, such as the cursor 315 (FIG. 3), at the client device 102, 104, 106 is positioned over the window 310 and detects user input, such as mouse clicks, at the window 310. Additional details regarding the operation of the program 402 are discussed below with reference to FIG. 5.

FIG. 4B illustrates details of the embedded program 404. As mentioned above, the embedded program may comprise JavaScript code embedded into the web page 300. The program 404 includes a sniffer 420, a timer 422, a page data retrieval module 424, and an image retrieval module 426. The sniffer 420 determines whether the plug-in 226 is of a predetermined type and presents the user with a pop-up window requesting the user install a plug-in of predetermined type if the sniffer 420 determines that the predetermined plug-in is not installed.

The timer 422 may comprise a timer, a counter, a clock, or other suitable mechanism for monitoring the passage of time. The timer 422 commences operation when the web page 300 (FIG. 3) loads into the browser 224 (FIG. 2) and is used for determining image or video rotation intervals, as discussed below with reference to FIG. 5. The page data retrieval module 424 retrieves an XML feed, or XML file, from the server cluster 108 (FIG. 1). As discussed in more detail below in FIG. 5, the XML feed may include text for populating at least a portion of the web page 300, the address of one or more images, the name of one or more video files, and the size of individual video files. The images may comprise JPEG images, for example. In some applications, the images may alternatively comprise GIF images. The image retrieval module 426 retrieves the one or more of the images identified in the XML feed from over the network 110 from the image server 124 or other suitable server.

FIG. 5 is a flowchart 500 depicting one example embodiment of a method in accordance with the present invention. Initially, at block 502, a user at the client device 102 (FIG. 1) downloads the web page 300 (FIG. 3) including embedded programs from the server cluster 108 (FIG. 1). The user (or another user) may alternatively download the web page 300 at one or more of the other client devices 104, 106. In particular, the client device 102 may download the web page 300 by transmitting an HTTP request to the server cluster 108 via the network interface 212 (FIG. 2) and over the network 100 (FIG. 1). In response to receiving the HTTP request, the server identified by the HTTP request receives the HTTP request and transmits the web page 300 associated with the HTTP request to the requesting client device. In one embodiment, the web server 122 receives the HTTP request and transmits the web page 300 over the network 100 to the client device 102. The client device 102 receives the web page 300 over the network interface 212 and the browser 224 loads the downloaded web page 300.

At block 504, the embedded program 404 (FIG. 4B), using the sniffer 420, determines whether the browser 224 (FIG. 2) includes a predetermined plug-in. In one embodiment, the sniffer 420 determines whether the browser 224 has a player plug-in of an appropriate type. In one embodiment, the plug-in of an appropriate type comprises Macromedia Flash plug-in. In other embodiments, other plug-ins may be alternatively employed.

If at block 504, the sniffer 420 determines that the browser 224 does not include the predetermined plug-in, execution proceeds to block 506, else execution proceeds to block 508. At block 506, the sniffer 508 causes a message to appear within the window 310 of the web page 300 prompting the user to install the predetermined plug-in and then returns execution to block 504.

At block 508, the program 404 (FIG. 4B) commences timer 422 (FIG. 4B) to measure a predetermined period of time. The length of the predetermined amount of time may vary. In one example embodiment, the length of the predetermined amount of time is in the range of about 8-10 seconds. After the timer 422 has been commenced, or started, execution proceeds to block 510.

At block 510, the page data retrieval module 424 (FIG. 4B) of the program 404 downloads page data from over the network 110 (FIG. 1) from the server cluster 108. The page data may comprise an XML data file, an XML feed, or data in another suitable format. The page data may include information such as text for populating at least a portion of the web page 300, the address of one or more images, such as a JPEG image, the name of one or more video files, the format of individual video files, and the like. Execution then proceeds to block 512.

At block 512, the image retrieval module 426 (FIG. 4B) of the program 404 retrieves a first image identified in the downloaded page data. As discussed above, the first image may comprise a JPEG image, the URL address of which may be provided in the page data. The image retrieval module 426 may retrieve the first image from over the network 110 (FIG. 1) from the server cluster 108. In particular, the first image may be stored at the image server 124 (FIG. 1). In other embodiments, the first image may be stored on an internet server (not shown) outside of the server cluster 108.

The image retrieval module 426 (FIG. 4B) then causes the downloaded first image to be displayed in the window 310 (FIG. 3) of the web page 300. In addition, the image retrieval module 426 populates the text field 311 (FIG. 3) adjacent the window 310 with a first set of text and a hyperlink. The first set of text is associated with the first image and is populated in the text field 311 at substantially the same time as the first image is displayed in the window 310.

In an example embodiment, the first set of text may comprise text relating to a first news story and the first image may comprise an image relating to the first news story. The hyperlink within the text field 311 may comprise a link to another web page containing a full story associated with the first image and the first set of text. In another embodiment, the first image may comprise an image of a first subject and the first set of text may comprise text relating to the first subject. The first subject may comprise, for example, an individual or item. Execution then proceeds to block 516.

At block 514, the sniffer 410 and the network connection checker 412 of the program 402 (FIG. 4A) respectively determine whether the version of the plug-in 226 (FIG. 2) comprises a predetermined version and whether an effective network connection exists with the server cluster 108 (FIG. 1). In particular, the sniffer 410 may determine the version, or release, of the plug-in 226 and presents the user a message within the window 310 if the plug-in 226 is not a predetermined version. This message may also identify the predetermined version and invite the user to install the predetermined version.

The network connection checker 412 (FIG. 4A) then performs a network connection check, such as by pinging one or more servers of the server cluster 108. By pinging one or more servers of the server cluster 108, the network connection checker 412 confirms the presence of an effective network connection. Other known methods suitable for performing a network connection check may alternatively be employed by the network connection checker 412. If the network connection checker 412 determines that an effective network connection does not exist, the network connection checker 412 displays a user message within the window 310 indicating that an effective network connection is not present, that an error occurred, or similar message. If the network connection checker 412 determines that an effective network connection exists, execution proceeds to block 516.

At block 516, the video data retrieval module 414 determines whether a play command has been received. In one embodiment, the user may position the cursor 315 (FIG. 3) over the button 313 on the web page 300 and mouse click or otherwise select the button 313 to generate a play command. As shown in FIG. 3, the button 313 is positioned within the window 310. The button 313 is positioned over the first image, which may be displayed within the window 310. If a play command has not been received, execution proceeds to block 518. If a play command has been received, execution proceeds to block 520.

At block 518, the timer 422 (FIG. 4B) of the program 404 determines whether the predetermined time has expired. If the timer 422 determines that the predetermined time has expired, execution proceeds to block 522, else execution returns to block 516.

At block 522, the image retrieval module 426 (FIG. 4B) of the program 404 downloads a second image, or a next image, and causes the second, or next, image to be displayed in the window 310. The image retrieval module 426 also replaces any existing text or hyperlink in the text field 311 with a second, or next, set of text and a second, or next, hyperlink. The second, or next, set of text and hyperlink are associated with the second, or next, image and are populated in the text field 311 at substantially the same time as the second, or next, image is displayed in the window 310. The image retrieval module 426 may obtain the second, or next, set of text and hyperlink from the page data retrieved by the page data retrieval module 424. Execution then proceeds to block 524.

At block 524, the timer 422 resets and execution returns to block 516. Thus, until a video play command is received, the timer 422 together with the image retrieval module 426 cause separate images and text to be displayed in the window 310 and text field 311, respectively, at intervals corresponding to the predetermined time of the timer. Hence, embodiments of the web page 300 are dynamic in that the web page 300 displays a predetermined sequence of images and text related to the images on a regular, or rotating, basis. This functionality permits a user viewing the web page 300 to view these images and text without having to leave the web page 300 while still being able to view or access the other sections of the web page 300.

As mentioned above, when a video play command is received at block 516, execution proceeds to block 520. At block 520, the timer 422 stops. In an alternate embodiment, at block 520, the timer 422 resets. Execution then proceeds to block 526.

At block 526, the video data retrieval module 414 retrieves video data from over the network 110 (FIG. 1) and plays the same in the window 310 (FIG. 3) using the plug-in 226 (FIG. 2). Pursuant to one embodiment, the video data may comprise data in a Flash Video (.flv) file or other suitable file format. In particular, the video data retrieval module 414 determines the identity of the video data to be retrieved using the page data retrieved by the page data retrieval module 424. This page data may include a name associated with the video data or an address from where the video data may be retrieved. The video data retrieval module 414, in one embodiment, is configured to retrieve video data from the video server 126 (FIG. 1) of the server cluster 108.

In one embodiment, the page data includes information regarding the format or aspect ratio of each video file. Video data may have different ratios of length (i.e., width) to height. Example aspect ratios include 200×150 and 16×9, although other ratios may alternatively be employed. The page data may include, for each video file, a format identifier indicating a video data format of the associated video file. The video data retrieval module 414 sizes the length-to-height (L/H) ratio of the window 310 (FIG. 3) of the web page 300 based on the format identifier associated with the video file. According to this embodiment, therefore, before playing a video file, the video data retrieval module 414 determines the format of the video data of the video data file based on the associated format identifier. The video data retrieval module 414 then sizes the dimensions, or aspect ratio, of the window 310 based on the determined format of the video data. Thus, video data of different formats, or aspect ratios, may be played at the web page 300 in a window appropriately sized for the format of a given video file.

Once the video data begins to play in the window 310 (FIG. 3), button 313 is visible only when cursor 315 is positioned over the window 310 as determined by the cursor detection module 416 (FIG. 4) and may comprise one or more sub-buttons. In one embodiment, the once the video data begins to play in the window 310 and the cursor 315 is positioned over the window 310, the button 313 comprises a first sub-button labeled “pause” and a second sub-button labeled “stop”.

Execution then proceeds to block 528, wherein the cursor detection module 416 determines whether the user has selected the pause sub-button. If the user has selected the pause sub-button the program 402 pauses playing of the video data and causes the button 313 to include the text “play,” “resume,” or an analogous text or symbol and execution proceeds to block 532. Else, execution proceeds to block 534. In addition, if the user selects the pause sub-button 402, the program 402 generates a shared object that identifies an amount of time the instant video file had been playing prior to selection of the pause button.

At block 532, the cursor detection module 416 determines whether a play command has been received by the user selecting the button 313. If no play command is detected at block 532, execution returns to the block 532 until a play command is detected. If the cursor detection module 416 detects a play command, execution proceeds to block 533 wherein the video data retrieval module 414 resumes playing the video data. In particular, in response to receiving the play command at block 532, the program 402 identifies how long the instant video file had been playing from the shared object and commences playing the instant video file at a point of the instant video file that corresponds with the amount of time identified in the shared object.

At block 534, the cursor detection module 416 determines whether a stop command has been received by the user selecting a stop sub-button of the button 313. If the cursor detection module 416 determines that the user has selected the stop sub-button of the button 313, execution returns to block 508, else execution proceeds to block 536.

At block 536, the video data retrieval module 414 (FIG. 4) determines whether all of the identified video data of the video file has been played. If the video data retrieval module 414 determines that all of the identified video data has been played, execution returns to block 508, else execution returns to block 528.

Accordingly, pursuant to the embodiment of FIG. 5, when a user downloads the page 300, such as from the web server 122, a first image will be displayed in the window 310 and a first set of text and a first hyperlink will be populated in the adjacent text field 311. The button 313 may also be present in window 310. The first image may comprise a first frame or a selected frame of an associated first video file. The associated first video file may be stored at the server cluster 108.

Alternatively, the first image may comprise a selected frame of the associated first video file. Upon user selection of the button 313, the embedded program 402 downloads and plays the first video file. If the user does not select the button 313 within a predetermined amount of time, the embedded program 404 replaces the first image with a second image and replaces the first set of text with a second set of text. Likewise, if the user again does not select the button 313 within a predetermined amount of time, the embedded program 404 replaces the second image and the second set of text with a third image and a second set of text. Thus, the user is presented with a series of images and related text until the user selects the button 313 or another link on the page 300.

In an alternate embodiment, rather than displaying the first image in the window 310 (FIG. 3) and waiting for the user to enter a play command, the program 402 (FIG. 4A) commences playing the first video file in the window 310 upon the page downloading without requiring entry of a play command from the user. Then, at the expiration of the predetermined time, or at the end of the first video file, the program 402 commences playing the second video data file. Thus, in this embodiment, upon downloading the page 300 (FIG. 3), the first video data file begins to play in the window 310. At the end of the first video data file, or at the end of a predetermined period of time, a second video data file beings to play. This process may continue until a predetermined set of video data files have each been sequentially played at the window 310. After playing the predetermined set of video data files a first time, the program 402 may replay the predetermined set of video data files.

Pursuant to another alternate embodiment, a user may, at any time after the page 300 (FIG. 3) is loaded, select one of the buttons 312. Each of the buttons 312 is associated with one or more of an image, a set of text and hyperlink, and a video file. Upon user selection of one of the buttons 312, the program 404 causes the associated image to be displayed in the window 310 and the associated set of text to be displayed in the text field 311. Then, user entry of a play command causes the program 402 to play the associated video file. Optionally, user selection of one of the buttons 312 causes the associated set of text and hyperlink to be populated into the test field 311 and causes the program 402 to commence playing the associated video file without first displaying the associated image.

In some example embodiments, the image and associated video data file, text, and hyperlink may be used in web page containing news stories. In these embodiments, the image may be a frame of an associated video data file and the text content relates to the image and the associated video file. The hyperlink links to a web page containing the full text of an associated news story.

In other example embodiments, the image and associated video data file, text, and hyperlink may be used in a web page containing one or more personal advertisements or messages. The image and video data may be uploaded to the video server 126 (FIG. 1) from a client 102, 104, 106, which may comprise a personal computer adapted with a camera or other imaging or recording device. The image in these embodiments may comprise an image of one or more individuals and the video data may comprise a video message from the one or more individuals. The text and hyperlink may include content that relates to the one or more individuals. The hyperlink may be operable to permit a user to transmit an email message to the one or more individuals.

This disclosure provides exemplary embodiments of the present invention. The scope of the present invention is not limited by these exemplary embodiments. Numerous variations, whether explicitly provided for by this disclosure or implied by this disclosure, may be implemented by one of ordinary skill in the art in view of this disclosure.

What is claimed is:

1. A method for displaying images and video within a web page, the method comprising:
downloading a web page including at least a display window, a timing mechanism for measuring expiration of a predetermined time period, and a video retrieval module;
commencing the timer;
displaying a first image in the display window;
playing at least a portion of a first video file within the display window in response to entry of a play command;
displaying a second image in the display window in response to the expiration of the predetermined time period as determined by the timing mechanism and no entry of the play command.

2. The method according to claim 1, wherein the timer comprises a component of a first embedded application and the video retrieval module comprises a second embedded application, the first and second applications being embedded in the web page.

3. The method according to claim 1, further comprising:
downloading page data including a first video file identifier;
wherein the playing the first video file within the display window further comprises streaming the first video file from a server using the first video file identifier.

4. The method according to claim 1, wherein the web page further comprises a sniffer, the method further comprising determining the presence of a plug-in using the sniffer.

5. The method according to claim 1, wherein the web page further comprises a text field adjacent the display window, the method further comprising:
downloading page data including a first video file identifier, a first image identifier, and a first set of text, the first set of text being associated with the first image and the first video file;
displaying the first set of the text in the text field adjacent the display window.

6. The method according to claim 1, further comprising downloading page data including a first video file identifier and a first video file format identifier, the first video file format identifier indicating a format of the first video file.

7. The method according to claim 6, further comprising sizing a display ratio of the display window based on the first video file format identifier.

8. The method according to claim 6, wherein the sizing the display ration of the display window further comprises sizing the display ratio of the display window between a 16×9 ratio or a 4×3 aspect ratio based on the first video file format identifier.

9. The method according to claim 1, further comprising:
receiving a pause command;
ceasing to play the first video file in response to the pause command;
generating a shared object indicating an amount of time the first video file had played prior to receipt of the pause command;
generating a shared object indicating an amount of time the first video file had played prior to receipt of the pause command;
in response to a resume command, playing the first video file beginning at a point in the first video file associated with the amount of time the first video file had played prior to receipt of the pause command, as provided by the shared object.

10. The method according to claim 1, further comprising:
receiving a stop command;
in response to the stop command resetting the timing mechanism and displaying an image in the display window.

11. The method according to claim 1, wherein the web page further comprises a set of buttons, each button being associated with an image and a set of text, the method further comprising:
in response to user selection of one of the buttons, displaying the image associated with the selected button in the display window and displaying the set of text associated with the selected button in a text field adjacent the display window.

12. The method according to claim 1, wherein the video retrieval module comprises ActionScript code and the timer comprises JavaScript code.

13. The method according to claim 1, further comprising stopping or resetting the timer in response to entry of the play command.

14. The method according to claim 1, further comprising displaying a third image in the display window subsequent to the displaying the second image, in response

15. The method according to claim 1, wherein the web page further comprises a text field adjacent the display window, the method further comprising:
downloading page data including a first video file identifier, a first image identifier, and a first set of text, the first set of text being associated with the first image and the first video file, the first set of text including a hyperlink to another web page associated with the first set of text;
displaying the first set of the text and the hyperlink in the text field adjacent the display window.

16. The method according to claim 15, wherein the page data further comprises an XML feed.

17. A method for displaying images and video within a web page, the method comprising:
downloading a web page including a display window, a text field, an embedded page data retrieval module and an embedded video retrieval module;
downloading page data separate from the web page, the page data comprising an image identifier, a video file identifier, and text associated with the image identifier;
downloading a first image using the image identifier;
displaying the first image in the display window;
playing at least a portion of a first video file associated with the video file identifier within the display window in response to entry of a play command;
displaying the text associated with the image identifier in the text field.

18. The method according to claim 17, wherein the page data further comprises an XML feed.

19. The method according to claim 17, wherein the page data further includes a hyperlink to a separate web page containing content associated with the text, and displaying the hyperlink in the text field.

20. The method according to claim 17, further comprising determining the installation of a plug-in of predetermined type using a sniffer embedded in the web page.

21. The method according to claim 17, further comprising:
testing a network connection with a video server;
downloading at least a portion of the first video file from the video server using the page data.

22. A method for displaying video within a web page, the method comprising:
downloading a web page including a display window, a timer, and a video retrieval module;
commencing the timer;
playing at least a portion of a first video file within the display window;
playing at least a portion of a second video file separate from the first video file within the display window in response to the end of the first video file or in response to the expiration of a predetermined time as determined by the timer.

23. The method for displaying video within a web page according to claim 22, further comprising:
providing a text field on the web page adjacent the display window;
populating the text field with a first set of text simultaneous with playing at least a portion of the first video file;
populating the text field with a second set of text simultaneous with playing at least a portion of the second video file.
